(19) United States
(12) Patent Application Publication
(10) Pub. No.: US 2026/0367731 A1
(43) Pub. Date: Nov. 19, 2026

(54) TOUCH CONTROL DISPLAY PANEL AND ELECTRONIC DEVICE INCLUDING SAME

(71) Applicants: BEIJING BOE DISPLAY TECHNOLOGY CO., LTD., Beijing (CN); BOE TECHNOLOGY GROUP CO., LTD., Beijing (CN); BEIJING BOE TECHNOLOGY DEVELOPMENT CO., LTD., Beijing (CN)

(72) Inventors: Wenjie HOU, Beijing (CN); Qiujie SU, Beijing (CN); Yingmeng MIAO, Beijing (CN); Dongchuan CHEN, Beijing (CN); Chongyang ZHAO, Beijing (CN); Xiaofeng YIN, Beijing (CN)

(21) Appl. No.: 18/995,994

(22) PCT Filed: Apr. 17, 2024
(86) PCT No.: PCT/CN2024/088207

§ 371 Date: Jan. 17, 2025

(30) Foreign Application Priority Data
May 31, 2023 (CN) 202310633110.0

(51) Int. Cl. G06F 3/041

(52) U.S. Cl. CPC G06F 3/0418

(57) ABSTRACT

A touch control display panel includes an operation area and a peripheral area surrounding it, wherein a plurality of data lines and a plurality of touch lines extend into the peripheral area. Each data line is electrically connected to a data line electrostatic discharge conductor through a data line electrostatic discharge unit, each touch control line is electrically connected to a touch control line electrostatic discharge conductor through a touch control line electrostatic discharge unit. Both the data line electrostatic discharge unit and the touch control line electrostatic discharge unit are configured to bring an input terminal and an output terminal into conduction in response to a voltage applied at the input terminal being greater than or equal to a discharge threshold voltage, and to break the conduction between the input and output terminals in response to the voltage at the input terminal being less than the discharge threshold voltage.

### RELATED APPLICATIONS

The present application is a 35 U.S.C. 371 national stage application of PCT International Application No. PCT/CN2024/088207 filed on Apr. 17, 2024, which claims the benefits of Chinese Patent Application No. 202310633110.0, the entire disclosures of which are incorporated herein by reference.

### TECHNICAL FIELD

The present disclosure relates to the field of display technology, in particular, to a touch control display panel, which includes an electrostatic discharge unit peripherally arranged, and also to an electronic device including the touch control display panel.

### BACKGROUND

Recently, electronic devices including a touch control display panel are increasingly and widely used. For an electronic device including a touch control display panel, the problem of electrostatic discharge due to the fact that a large amount of static electricity is accumulated on the touch control display panel due to touch control operation and friction during use is also becoming more and more focused. In addition, in an electronic device including a touch control display panel, array detection on data lines and touch control lines is also very important.

For an electronic device including a conventional non-touch-control display panel, since only data lines exist, the electrostatic discharge protection for the data lines generally adopts a single-row arrangement. However, for an electronic device including a touch control display panel, the conventional single-row arrangement for electrostatic discharge protection of data lines and touch control lines leads to mutual interference in detecting defects in data lines and touch control lines, and makes an excessive number of electrostatic discharge thin-film transistors connected to the electrostatic discharge circuit, which is disadvantageous for an arrangement of electrostatic discharge transistors and voltage division in the electrostatic discharge of the touch control display panel.

### SUMMARY

According to a first aspect of the present disclosure, there is provided a touch control display panel including: an operation area configured to perform display and sense a touch control operation from a user; a peripheral area surrounding the operation area; a plurality of data lines and a plurality of touch control lines extending from the operation area into the peripheral area, and in the peripheral area, each data line being electrically connected with an input terminal of a data line electrostatic discharge unit, an output terminal of the data line electrostatic discharge unit being electrically connected with a data line electrostatic discharge conductor, each touch control line being electrically connected with an input terminal of a touch control line electrostatic discharge unit, an output terminal of the touch control line electrostatic discharge unit being electrically connected with a touch control line electrostatic discharge conductor. The data line electrostatic discharge unit is configured to: bring the input terminal and the output terminal of the data line electrostatic discharge unit into conduction in response to a voltage applied at the input terminal of the data line electrostatic discharge unit being greater than or equal to a discharge voltage threshold, and break the conduction between the input terminal and the output terminal of the data line electrostatic discharge unit in response to a voltage applied at the input terminal of the data line electrostatic discharge unit being less than the discharge voltage threshold. The touch control line electrostatic discharge unit is configured to: bring the input terminal and the output terminal of the touch control line electrostatic discharge unit into conduction in response to a voltage applied at the input terminal of the touch control line electrostatic discharge unit being greater than or equal to the discharge voltage threshold, and break the conduction between the input terminal and the output terminal of the touch control line electrostatic discharge unit in response to a voltage at the input terminal of the touch control line electrostatic discharge unit being less than the discharge voltage threshold.

In some exemplary embodiments, the data line electrostatic discharge conductor is electrically connected with an input terminal of a redundancy data line electrostatic discharge unit, and an output terminal of the redundancy data line electrostatic discharge unit is electrically connected with a common voltage wiring in the peripheral area; and/or the touch control line electrostatic discharge conductor is electrically connected with an input terminal of a redundant touch control line electrostatic discharge unit, and an output terminal of the redundant touch control line electrostatic discharge unit is also electrically connected with the common voltage wiring.

In some exemplary embodiments, a plurality of data line electrostatic discharge units are arranged in a first row, a plurality of touch control line electrostatic discharge units are arranged in a second row, the first row and the second row are arranged in parallel.

In some exemplary embodiments, the touch control display panel further includes a plurality of chips arranged in the peripheral area and a common voltage wiring arranged at a middle position of two adjacent chips. For the common voltage wiring: data line electrostatic discharge conductors include a first side data line electrostatic discharge conductor at a first side of the common voltage wiring and a second side data line electrostatic discharge conductor at a second side of the common voltage wiring, the second side is opposite to the first side, the first side data line electrostatic discharge conductor and the second side data line electrostatic discharge conductor are electrically connected through vias and a jumper line; touch control line electrostatic discharge conductors include a first side touch control line electrostatic discharge conductor at the first side of the common voltage wiring and a second side touch control line electrostatic discharge conductor at the second side of the common voltage wiring, the second side is opposite to the first side, the first side touch control line electrostatic discharge conductor and the second side touch control line electrostatic discharge conductor are electrically connected through vias and a jumper line.

In some exemplary embodiments, for the common voltage wiring: the first side data line electrostatic discharge conductor is electrically connected with an input terminal of a first side redundancy data line electrostatic discharge unit, and an output terminal of the first side redundancy data line electrostatic discharge unit is electrically connected with the common voltage wiring; the second side data line electrostatic discharge conductor is electrically connected with an input terminal of a second side redundancy data line electrostatic discharge unit, and an output terminal of the second side redundancy data line electrostatic discharge unit is electrically connected with the common voltage wiring; the first side touch control line electrostatic discharge conductor is electrically connected with an input terminal of a first side redundant touch control line electrostatic discharge unit, and an output terminal of the first side redundant touch control line electrostatic discharge unit is electrically connected with the common voltage wiring; the second side touch control line electrostatic discharge conductor is electrically connected with an input terminal of a second side redundant touch control line electrostatic discharge unit, and an output terminal of the second side redundant touch control line electrostatic discharge unit is electrically connected with the common voltage wiring.

In some exemplary embodiments, for the common voltage wiring: at the first side of the common voltage wiring, a plurality of data line electrostatic discharge units are arranged in a first row, a plurality of touch control line electrostatic discharge units are arranged in a second row, and the first row and the second row are arranged in parallel; at the second side of the common voltage wiring, a plurality of data line electrostatic discharge units are arranged in a first row, a plurality of touch control line electrostatic discharge units are arranged in a second row, and the first row and the second row are arranged in parallel.

In some exemplary embodiments, the touch control line electrostatic discharge conductor is electrically connected with a ground line.

In some exemplary embodiments, a plurality of data line electrostatic discharge units are arranged in a first row, a plurality of touch control line electrostatic discharge units are arranged in a second row, and the first row and the second row are arranged in parallel.

In some exemplary embodiments, a plurality of data line electrostatic discharge units and a plurality of touch control line electrostatic discharge units are arranged in a row.

In some exemplary embodiments, the data line electrostatic discharge conductor is electrically connected with an input terminal of an additional data line electrostatic discharge unit, and an output terminal of the additional data line electrostatic discharge unit is electrically connected with a common voltage wiring in the peripheral area; the touch control line electrostatic discharge conductor is electrically connected with an input terminal of an additional touch control line electrostatic discharge unit, and an output terminal of the additional touch control line electrostatic discharge unit is electrically connected with the common voltage wiring in the peripheral area.

In some exemplary embodiments, the data line electrostatic discharge conductor is electrically connected with a line for testing data line.

In some exemplary embodiments, the touch control display panel further includes a plurality of chips arranged in the peripheral area, ground pins of adjacent two chips are electrically connected through a ground line between them, the ground line is at a side of the chip close to the operation area, and an orthographic projection of the ground line onto the touch control display panel is at least partially overlapped with an orthographic projection of a black matrix of the touch control display panel onto the touch control display panel.

In some exemplary embodiments, an orthographic projection of the common voltage wiring in the peripheral area onto the touch control display panel is at least partially overlapped with the orthographic projection of the black matrix onto the touch control display panel.

In some exemplary embodiments, the peripheral area includes a terminal interface side area and a terminal interface opposite side area that is opposite to the terminal interface side area, the terminal interface side area is provided with at least one chip, and the terminal interface opposite side area is provided with the data line electrostatic discharge unit and the touch control line electrostatic discharge unit. The plurality of data lines and the plurality of touch control lines extend from the operation area into the terminal interface side area to be electrically connected with the at least one chip, and the plurality of data lines and the plurality of touch control lines also extend from the operation area into the terminal interface opposite side area to be electrically connected with corresponding data line electrostatic discharge units and corresponding touch control line electrostatic discharge units, respectively.

In some exemplary embodiments, the peripheral area includes a terminal interface side area and a terminal interface opposite side area that is opposite to the terminal interface side area, the terminal interface side area is provided with at least one chip, the data line electrostatic discharge unit and the touch control line electrostatic discharge unit. The plurality of data lines and the plurality of touch control lines extend from the operation area into the terminal interface side area to be electrically connected with the at least one chip, and are electrically connected with corresponding data line electrostatic discharge units and corresponding touch control line electrostatic discharge units, respectively.

In some exemplary embodiments, the peripheral area includes a terminal interface side area and a terminal interface opposite side area that is opposite to the terminal interface side area, the terminal interface side area is provided with at least one chip, the terminal interface side area and the terminal interface opposite side area are both provided with the data line electrostatic discharge unit and the touch control line electrostatic discharge unit. The plurality of data lines and the plurality of touch control lines extend from the operation area into the terminal interface side area to be electrically connected with the at least one chip, and be electrically connected with corresponding data line electrostatic discharge units and corresponding touch control line electrostatic discharge units, respectively. The plurality of data lines and the plurality of touch control lines also extend from the operation area into the terminal interface opposite side area to be electrically connected with corresponding data line electrostatic discharge units and corresponding touch control line electrostatic discharge units, respectively.

In some exemplary embodiments, the peripheral area includes a terminal interface side area and a terminal interface opposite side area that is opposite to the terminal interface side area, the terminal interface side area is provided with at least one chip, the terminal interface opposite side area is also provided with at least one chip, the terminal interface side area and the terminal interface opposite side area are both provided with the data line electrostatic discharge unit and the touch control line electrostatic discharge unit. The plurality of data lines and the plurality of touch control lines extend from the operation area into the terminal interface side area to be electrically connected with at least one chip in the terminal interface side area, and be electrically connected with corresponding data line electrostatic discharge units and corresponding touch control line electrostatic discharge units in the terminal interface side area, respectively. The plurality of data lines and the plurality of touch control lines also extend from the operation area into the terminal interface contralateral area to be electrically connected with at least one chip in the terminal interface opposite side area, and be electrically connected with corresponding data line electrostatic discharge units and corresponding touch control line electrostatic discharge units in the terminal interface opposite side area, respectively.

In some exemplary embodiments, a circuit structure of the data line electrostatic discharge unit and the touch control line electrostatic discharge unit includes: a first transistor, a control electrode and a first electrode of which are both electrically connected with the input terminal; a second transistor, a first electrode of which is electrically connected with the control electrode of the first transistor, and a control electrode and a second electrode of which are electrically connected with a second electrode of the first transistor; a third transistor, a first electrode and a control electrode of which are both electrically connected with the second electrode of the second transistor; and a fourth transistor, a first electrode of which is electrically connected with the control electrode of the third transistor, a control electrode and a second electrode of which are electrically connected with a second electrode of the third transistor and also electrically connected with the output terminal. The first transistor, the second transistor, the third transistor and the fourth transistor are N-type transistors.

In some exemplary embodiments, the first transistor, the second transistor, the third transistor and the fourth transistor are thin film transistors.

According to a second aspect of the present disclosure, there is provided an electronic device including the touch control display panel according to the first aspect of the present disclosure and various exemplary embodiments thereof.

### BRIEF DESCRIPTION OF DRAWINGS

Hereinafter, exemplary embodiments of the present disclosure will be described in detail with reference to the accompanying drawings, in which:

FIGS. 1a and 1b schematically illustrate touch control display panels according to various exemplary embodiments of the present disclosure;

FIG. 2 schematically illustrates an electrostatic discharge arrangement applicable to the touch control display panel according to the present disclosure, according to an exemplary embodiment of the present disclosure;

FIG. 3 schematically illustrates a circuit structure of an electrostatic discharge unit according to an exemplary embodiment of the present disclosure;

FIG. 4 schematically illustrates an electrostatic discharge arrangement applicable to the touch control display panel according to the present disclosure, according to another exemplary embodiment of the present disclosure;

FIG. 5 schematically illustrates an electrostatic discharge arrangement applicable to the touch control display panel according to the present disclosure, according to another exemplary embodiment of the present disclosure;

FIG. 6 schematically illustrates an electrostatic discharge arrangement applicable to the touch control display panel according to the present disclosure, according to another exemplary embodiment of the present disclosure;

FIG. 7 schematically illustrates an electrostatic discharge arrangement applicable to the touch control display panel according to the present disclosure, according to another exemplary embodiment of the present disclosure;

FIG. 8 schematically illustrates an electrostatic discharge arrangement applicable to the touch control display panel according to the present disclosure, according to another exemplary embodiment of the present disclosure;

FIGS. 9a and 9b schematically illustrate a situation that an electrostatic discharge arrangement according to various exemplary embodiments of the present disclosure is applied in a touch control display panel;

FIG. 10 schematically illustrates connections from the chip and the electrostatic discharge unit to the signal lines respectively when the chip and the electrostatic discharge unit are located in the same area of the touch control display panel;

FIG. 11 schematically illustrates the structure of an electronic device according to an exemplary embodiment of the present disclosure in the form of a block diagram.

It should be understood that the drawings are merely schematic illustrations of exemplary embodiments of the present disclosure, and are not intended to limit the present disclosure, nor are they required to be drawn to scale. Furthermore, in the drawings, the same or similar features are indicated with the same or similar reference numerals.

### DETAILED DESCRIPTION

Various exemplary embodiments of the present disclosure are described below in conjunction with the drawings to enable those skilled in the art to fully understand and implement the technical solutions according to the present disclosure.

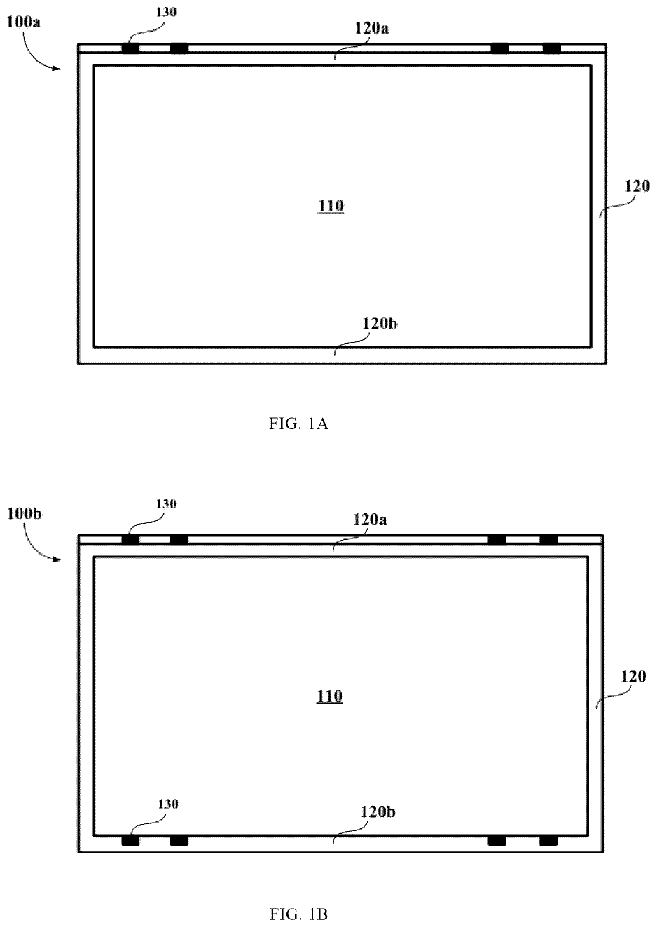

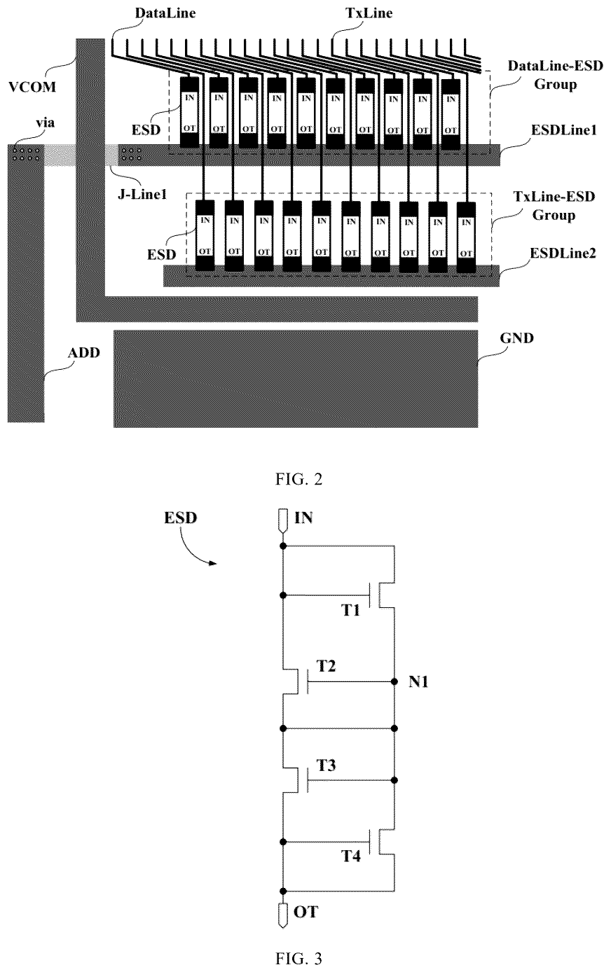

Referring to FIGS. 1a and 1b, touch control display panels according to various exemplary embodiments of the present disclosure are schematically illustrated. As shown in FIG. 1a, the touch control display panel 100a includes an operation area 110 and a peripheral area 120 surrounding the operation area 110. The operation area 110 (hereinafter also referred to as an AA area) may be configured to display contents and sense a touch control operation of a user. The peripheral area 120 surrounds the operation area 110 and includes a terminal interface side area 120a (hereinafter also referred to as DP side area) and a terminal interface opposite side area 120b (hereinafter also referred to as DPO side area) opposite to the DP side area 120a. In the DP side area 120a, the touch control display panel 100 may be provided with at least one chip 130, such as a chip on film (i.e., COF), a chip on glass (i.e., COG). A plurality of data lines and touch control lines (not shown in FIG. 1a) extend from the AA area 110 of the touch control display panel 100a into the DP side area 120a and/or the DPO side area 120b. Accordingly, the touch control display panel 100a shown in FIG. 1a is a touch control display panel driven from a single side. As shown in FIG. 1b, the structure of the touch control display panel 100b is substantially the same as the touch control display panel 100a shown in FIG. 1a, except that at least one chip 130, which may be a COF or a COG, is also provided in the DPO side area 120b of the touch control display panel 100b, and a plurality of data lines and touch control lines (not shown in FIG. 1b) extend from the AA area 110 of the touch control display panel 100b into the DP side area 120a and the DPO side area 120b. Furthermore, the chips 130 in the DPO side area 120b may be arranged to be aligned with the chips 130 in the DP side area 120a, or may be arranged to be offset from the chips 130 in the DP side area 120a. Accordingly, the touch control display panel 100b shown in FIG. 1b is a touch control display panel driven from both sides.

Referring to FIG. 2, an electrostatic discharge arrangement according to an exemplary embodiment of the present disclosure and applicable to the touch control display panel shown in FIG. 1a or FIG. 1b is schematically illustrated. As shown in FIG. 2, in the electrostatic discharge arrangement, a plurality of data lines DataLine and a plurality of touch control lines TxLine extend from the AA area 110 into the peripheral area 120. Each data line DataLine is electrically connected to the input terminal IN of an electrostatic discharge unit ESD, the output terminal OT of which is electrically connected to a data line electrostatic discharge conductor ESDLine1, and each touch control line TxLine is electrically connected to the input terminal IN of another electrostatic discharge unit ESD, the output terminal OT of which is electrically connected to a touch control line electrostatic discharge conductor ESDLine2. Accordingly, in the electrostatic discharge arrangement shown in FIG. 2, the electrostatic discharge units ESD arranged in the peripheral area 120 are divided into two groups, i.e., a data line electrostatic discharge unit group DataLine-ESD Group and a touch control line electrostatic discharge unit group TxLine-ESD Group. Each electrostatic discharge unit ESD in the data line electrostatic discharge unit group DataLine-ESD Group is respectively connected between a corresponding data line DataLine and the data line electrostatic discharge conductor ESDLine1, and each electrostatic discharge unit ESD in the touch control line electrostatic discharge unit group TxLine-ESD Group is respectively connected between a corresponding touch control line TxLine and the touch control line electrostatic discharge conductor ESDLine2. The electrostatic discharge unit ESD is configured to: in response to a voltage applied at the input terminal IN being greater than or equal to a discharge threshold voltage, bring the input terminal IN and the output terminal OT into conduction; and in response to a voltage at the input terminal IN being less than the discharge threshold voltage, break conduction between the input terminal IN and the output terminal OT. The data line electrostatic discharge conductor ESDLine1 and the touch control line electrostatic discharge conductor ESDLine2 are provided with sufficient length and width, such that they have sufficient capacity to accommodate electric charge transferred from the corresponding data line(s) DataLine and/or touch control line(s) TxLine. Furthermore, as shown in FIG. 2, the data line electrostatic discharge conductor ESDLine1 may also be electrically connected with a line for testing data line ADD arranged in the peripheral area 120 of the touch control display panel, for example, through vias VIA and a jumper line J-Line1, whereby, not only the anti-static capability on the data line can be improved, but also the data line DataLine can be tested via the data line electrostatic discharge conductor ESDLine1 with the line for testing data line ADD. In FIG. 2, the data line electrostatic discharge unit group DataLine-ESD Group and the touch control line electrostatic discharge unit group TxLine-ESD Group are shown to adopt a two-row arrangement. However, this is not necessary, and in other exemplary embodiments, the data line electrostatic discharge unit group DataLine-ESD Group and the touch control line electrostatic discharge unit group TxLine-ESD Group may be arranged in a single row, which will be described in detail below.

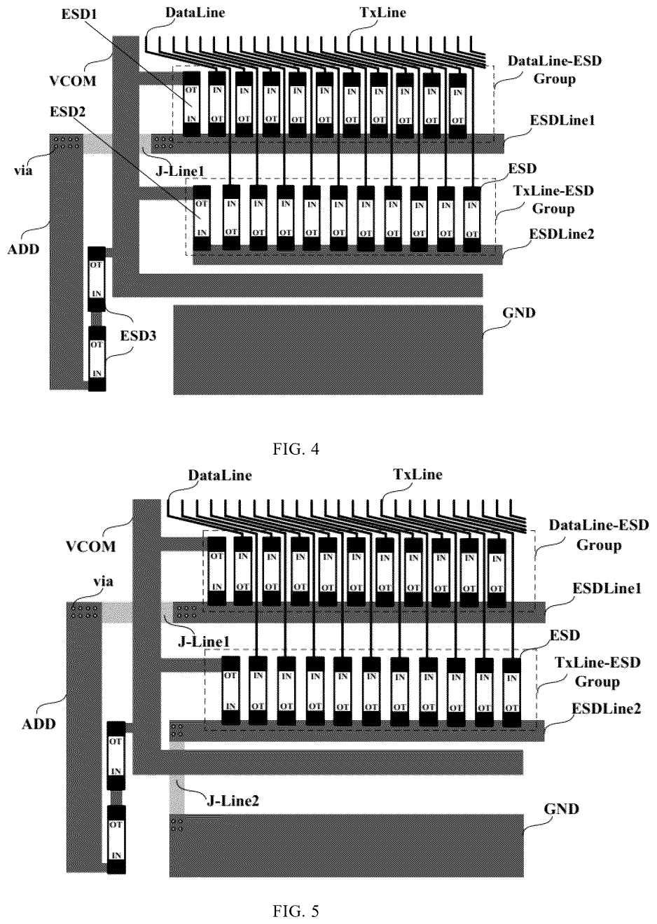

Referring to FIG. 3, a circuit structure of an electrostatic discharge unit according to an exemplary embodiment of the present disclosure is schematically illustrated. As shown in FIG. 3, the electrostatic discharge unit ESD includes four N-type transistors. It should be understood that the transistors employed in this exemplary embodiment of the present disclosure may be a thin film transistor or a field effect transistor or other devices having the same characteristics. Transistors are typically fabricated such that their source electrode and drain electrode are used interchangeably, so that their source electrode and drain electrode do not differ substantially in the description of the connection relationship. In an exemplary embodiment of the present disclosure, to distinguish a source electrode and a drain electrode of a transistor, one of the electrodes is referred to as a first electrode, the other electrode is referred to as a second electrode, and a gate electrode thereof is referred to as a control electrode. A first electrode and a control electrode of the first transistor T1 are electrically connected to the input terminal IN, and a second electrode thereof is electrically connected to a node N1. A first electrode of the second transistor T2 is electrically connected to the input terminal IN, and a control electrode and a second electrode thereof are electrically connected to the node N1. A first electrode and a control electrode of the third transistor T3 are electrically connected to the node N1, and a second electrode thereof is electrically connected to the output terminal OT. A first electrode of the fourth transistor T4 is electrically connected to the node N1, and a control electrode and a second electrode thereof are electrically connected to the output terminal OT.

Therefore, when a voltage applied at the input terminal IN of the electrostatic discharge unit ESD is greater than or equal to the discharge voltage threshold, the first transistor T1 is turned on, so that the voltage at the input terminal IN is also applied to the node N1. Therefore, the second transistor T2 and the third transistor T3 are also turned on, so that the input terminal IN and the output terminal OT are brought into conduction. At this time, the fourth transistor T4 is also turned on. When a voltage applied at the input terminal IN of the electrostatic discharge unit ESD is less than the discharge voltage threshold, each transistor will be in a cut-off state, thereby breaking conduction between the input terminal IN and the output terminal OT of the electrostatic discharge unit ESD. Furthermore, the circuit structure of the electrostatic discharge unit ESD shown in FIG. 3 is symmetrical, that is, the electrostatic discharge unit ESD can perform the same function when an input voltage is applied at the output terminal OT and the input terminal IN of the electrostatic discharge unit ESD is used as the output terminal thereof. It should be understood that the circuit structure of the electrostatic discharge unit ESD shown in FIG. 3 is exemplary and not limiting. The present disclosure does not make any limitation on the circuit structure of the electrostatic discharge unit ESD as long as it can realize the functions of the electrostatic discharge unit described in the present disclosure.

From the above description, by grouping the electrostatic discharge units for the data lines and the touch control lines in the touch control display panel, not only the electrostatic charge accumulated on the data lines and the touch control lines in the touch control display panel can be eliminated, the discharging capability to the electrostatic charge is increased, so that the anti-static capability of the touch control display panel is improved, and also the mutual interference of voltages between the data lines and the touch control lines can be avoided, so that the respective defect detection rates when detecting the data lines and the touch control lines are ensured.

Referring to FIG. 4, an electrostatic discharge arrangement according to another exemplary embodiment of the present disclosure and applicable to the touch control display panel shown in FIG. 1a or FIG. 1b is schematically illustrated. The electrostatic discharge arrangement shown in FIG. 4 is substantially the same as the electrostatic discharge arrangement shown in FIG. 2, modified only in some parts. Accordingly, the description below will be made with respect to where the electrostatic discharge arrangement shown in FIG. 4 differs from the electrostatic discharge arrangement shown in FIG. 2, and the same parts will not be repeatedly described.

As shown in FIG. 4, in this electrostatic discharge arrangement, the data line electrostatic discharge conductor ESDLine1 is electrically connected with the input terminal IN of an electrostatic discharge unit ESD1, and the output terminal OT of this electrostatic discharge unit ESD1 is electrically connected with the common voltage wiring VCOM in the peripheral area 120; the touch control line electrostatic discharge conductor ESDLine2 is also electrically connected to an input terminal IN of an electrostatic discharge unit ESD2, and the output terminal OT of the electrostatic discharge unit ESD2 is likewise electrically connected to the common voltage wiring VCOM in the peripheral area 120. In the touch control display panel, the common voltage wiring VCOM is typically a large wiring network arranged around the AA area 110 throughout the peripheral area 120. Thus, the electrostatic discharge arrangement shown in FIG. 4 ensures that the large common voltage wiring VCOM can be used to share and transfer electric charge in the case of higher electrostatic voltages, thereby enabling more effective electrostatic protection of the data line DataLine and the touch control line TxLine. Furthermore, in the electrostatic discharge arrangement shown in FIG. 4, the line for testing data line ADD electrically connected to the data line electrostatic discharge conductor ESDLine1 is electrically connected to the common voltage wiring VCOM through two series-connected electrostatic discharge units ESD3. The purpose of such an arrangement is also to ensure that the large common voltage wiring VCOM can be used for voltage division and electric charge transfer in the case of higher electrostatic voltages to further improve electrostatic protection of the data line DataLine. However, in other exemplary embodiments, the line for testing data line ADD may also be arranged to be electrically connected to the data line electrostatic discharge conductor ESDLine1, but not directly electrically connected to the common voltage wiring VCOM.

Referring to FIG. 5, an electrostatic discharge arrangement according to yet another exemplary embodiment of the present disclosure and applicable to the touch control display panel shown in FIG. 1a or FIG. 1b is schematically illustrated. The electrostatic discharge arrangement shown in FIG. 5 is substantially the same as the electrostatic discharge arrangement shown in FIG. 4, modified only in some parts. Accordingly, the description below will be made with respect to where the electrostatic discharge arrangement shown in FIG. 5 differs from the electrostatic discharge arrangement shown in FIG. 4, and the same parts will not be repeatedly described.

As shown in FIG. 5, in this electrostatic discharge arrangement, the touch control line electrostatic discharge conductor ESDLine2 is electrically connected to the ground line GND, for example through vias and a jumper line J-Line2. Therefore, in the electrostatic discharge arrangement shown in FIG. 5, at the time of array detection on the touch control display panel, the ground line GND can be applied with a test voltage signal as an applied voltage signal line to test the defect rate of the touch control line TxLine, and after the array detection is completed, the ground line GND can still be used as a ground line. It can be seen that the electrostatic discharge arrangement shown in FIG. 5 on the one hand can improve the defect detection rate of the touch control line TxLine, and on the other hand, by electrically connecting the touch control line electrostatic discharge conductor ESDLine2 with the ground line GND, can utilize the ground network for voltage division and electric charge transfer, thereby improving the electrostatic protection of the touch control line TxLine.

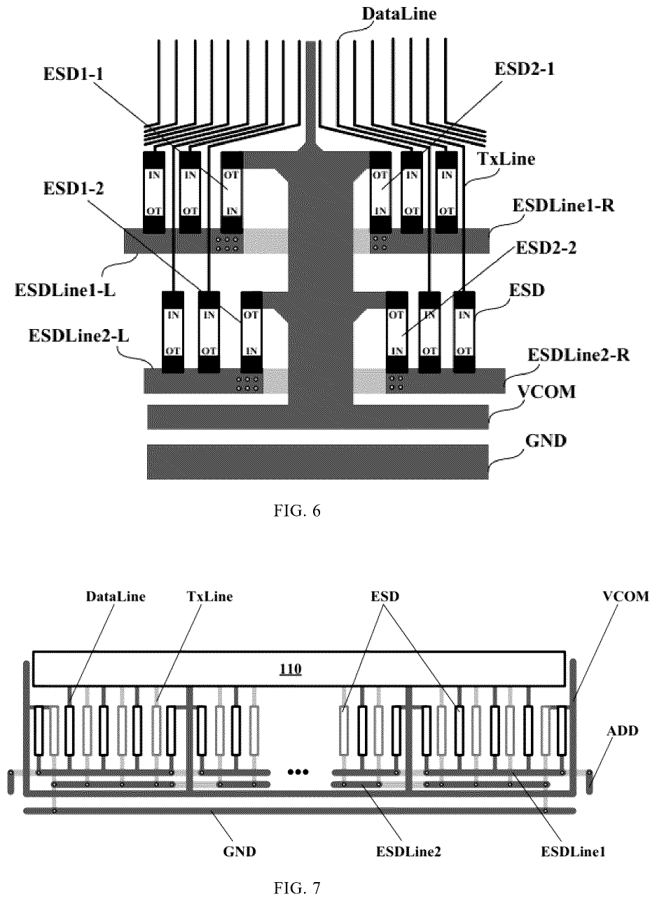

Referring to FIG. 6, an electrostatic discharge arrangement according to yet another exemplary embodiment of the present disclosure and applicable to the touch control display panel shown in FIG. 1a or FIG. 1b is schematically illustrated. As shown in FIG. 6, the electrostatic discharge arrangement may be arranged between two adjacent chips 130 in the peripheral area 120 of the touch control display panel. In this electrostatic discharge arrangement, a common voltage wiring VCOM is provided between two adjacent chips 130. For the plurality of data lines DataLine and the plurality of touch control lines TxLine on the first side of the common voltage wiring VCOM, each data line DataLine is electrically connected with the input terminal IN of an electrostatic discharge unit ESD, the output terminal OT of the electrostatic discharge unit ESD is electrically connected to the first side data line electrostatic discharge conductor ESDLine1-L, and each touch control line TxLine is also electrically connected to the input terminal IN of an electrostatic discharge unit ESD, the output terminal OT of the electrostatic discharge unit ESD is electrically connected to the first side touch control line electrostatic discharge conductor ESDLine2-L. For the plurality of data lines DataLine and the plurality of touch control lines TxLine on the second side of the common voltage wiring VCOM, each data line DataLine is electrically connected with the input terminal IN of an electrostatic discharge unit ESD, the output terminal OT of the electrostatic discharge unit ESD is electrically connected to the second side data line electrostatic discharge conductor ESDLine1-R, and each touch control line TxLine is also electrically connected to the input terminal IN of an electrostatic discharge unit ESD, the output terminal OT of the electrostatic discharge unit ESD is electrically connected to the second side touch control line electrostatic discharge conductor ESDLine2-R. The first side data line electrostatic discharge conductor ESDLine1-L is electrically connected with the input terminal IN of an electrostatic discharge unit ESD1-1, and the output terminal OT of that electrostatic discharge unit ESD1-1 is electrically connected to the common voltage wiring VCOM; the first side touch control line electrostatic discharge conductor ESDLine2-L is also electrically connected to the input terminal IN of an electrostatic discharge unit ESD1-2, and the output terminal OT of the electrostatic discharge unit ESD1-2 is likewise electrically connected to the common voltage wiring VCOM. The second side data line electrostatic discharge conductor ESDLine1-R is electrically connected with the input terminal IN of an electrostatic discharge unit ESD2-1, and the output terminal OT of the electrostatic discharge unit ESD2-1 is electrically connected to the common voltage wiring VCOM; the second side touch control line electrostatic discharge conductor ESDLine2-R is also electrically connected to the input terminal IN of an electrostatic discharge unit ESD2-2, and the output terminal OT of the electrostatic discharge unit ESD2-2 is likewise electrically connected to the common voltage wiring VCOM. The first side data line electrostatic discharge conductor ESDLine1-L and the second side data line electrostatic discharge conductor ESDLine1-R are electrically connected by respective vias and a jumper line, and the first side touch control line electrostatic discharge conductor ESDLine2-L and the second side touch control line electrostatic discharge conductor ESDLine2-R are also electrically connected by respective vias and a jumper line. On each side of the common voltage wiring VCOM, the electrostatic discharge units ESD electrically connected to the data lines DataLine and the electrostatic discharge units ESD electrically connected to the touch control lines TxLine are shown in a two-row arrangement.

Thus, the electrostatic discharge arrangement shown in FIG. 6, on the one hand, improves voltage division and electric charge transfer by a double-row arrangement of the electrostatic discharge units ESD and the common voltage wiring VCOM, thereby improving electrostatic protection for the data lines and the touch control lines. On the other hand, the first, second side data line electrostatic discharge conductors and the first, second side touch control line electrostatic discharge conductors on both sides of the common voltage wiring VCOM are electrically connected across the common voltage wiring through vias and jumper lines, respectively, so that it is possible to prevent the data line electrostatic discharge conductor and/or the touch control line electrostatic discharge conductor from accumulating a large amount of electrostatic charge because they are too long, and resulting in further improvement on the electrostatic protection of the data line and the touch control line.

Referring to FIG. 7, an electrostatic discharge arrangement according to yet another exemplary embodiment of the present disclosure and applicable to the touch control display panel shown in FIG. 1a or FIG. 1b is schematically illustrated. As shown in FIG. 7, a plurality of data lines DataLine and a plurality of touch control lines TxLine are electrically connected to input terminals of corresponding electrostatic discharge units ESD, respectively. All the electrostatic discharge units ESD adopt a single row arrangement, wherein the output terminal of an electrostatic discharge unit ESD electrically connected with a data line DataLine is electrically connected to the data line electrostatic discharge conductor ESDLine1, and an output terminal of an electrostatic discharge unit ESD electrically connected with a touch control line TxLine is electrically connected to the touch control line electrostatic discharge conductor ESDLine2. Therefore, all the electrostatic discharge units ESD are still divided into two groups, i.e., a data line electrostatic discharge unit group and a touch control line electrostatic discharge unit group. The data line electrostatic discharge conductor ESDLine1 is divided into a plurality of segments by a corresponding common voltage wiring VCOM, with the segments being electrically connected by corresponding vias and jumper lines, and the touch control line electrostatic discharge conductor ESDLine2 is also divided into a plurality of segments by a corresponding common voltage wiring VCOM, with the segments being electrically connected by corresponding vias and jumper lines. The data line electrostatic discharge conductor ESDLine1 and the touch control line electrostatic discharge conductor ESDLine2 are electrically connected with the common voltage wiring VCOM through corresponding electrostatic discharge units ESD, respectively. Furthermore, the data line electrostatic discharge conductor ESDLine1 is also electrically connected with the line for testing data line ADD through corresponding vias and a jumper line, and the touch control line electrostatic discharge conductor ESDLine2 is also electrically connected with the ground line GND through corresponding vias and a jumper line.

It can be seen that the electrostatic discharge arrangement shown in FIG. 7 combines the advantages of the electrostatic discharge arrangements shown in FIGS. 2, 4, 5 and 6, while also considering the narrowing of the bezel of the touch control display panel.

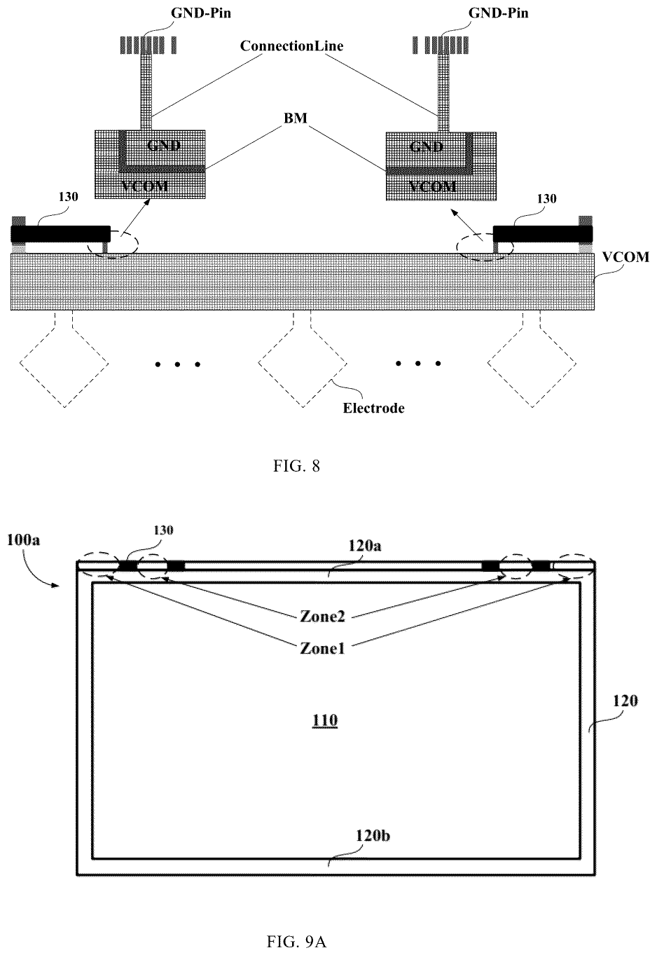

Referring to FIG. 8, an electrostatic discharge arrangement according to yet another exemplary embodiment of the present disclosure and applicable to the touch control display panel shown in FIG. 1a or FIG. 1b is schematically illustrated. As shown in FIG. 8, in the electrostatic discharge arrangement, a side of each chip 130 near the AA area adds a ground pin GND-Pin, the ground pin GND-Pin of these chips is electrically connected with the ground line GND through a connection line ConnectionLine, and the ground line GND is at least partially covered by the color film-side black matrix of the touch control display panel (the projection BM of the color film-side black matrix onto the touch control display panel is schematically shown in FIG. 8). That is, the orthographic projection of the ground line onto the touch control display panel is at least partially overlapped with the orthographic projection of the black matrix of the touch control display panel onto the touch control display panel, so that a capacitor is formed between the black matrix and the ground line GND. The wire of the electrode Electrode of a touch control sensor in the touch control display panel 110 is also covered by the color film-side black matrix, so that a capacitor is also formed between the black matrix and the wire. The two capacitors together form a parallel capacitor. Therefore, when the touch control display panel 110 accumulates a large amount of electrostatic charge due to touch control operation and friction, etc., the electric charge can be discharged from the electrode Electrode to the ground through the parallel capacitor, thereby further improving the electrostatic protection of the touch control display panel. Further, as shown in FIG. 8, the orthographic projection of the common voltage wiring VCOM onto the touch control display panel also overlaps at least partially with the orthographic projection of the color film-side black matrix onto the touch control display panel, thereby also constituting a capacitor with the black matrix. The capacitor can also be used to transfer the electrostatic charge accumulated on the electrode Electrode, thereby enabling improved electrostatic protection of the touch control display panel.

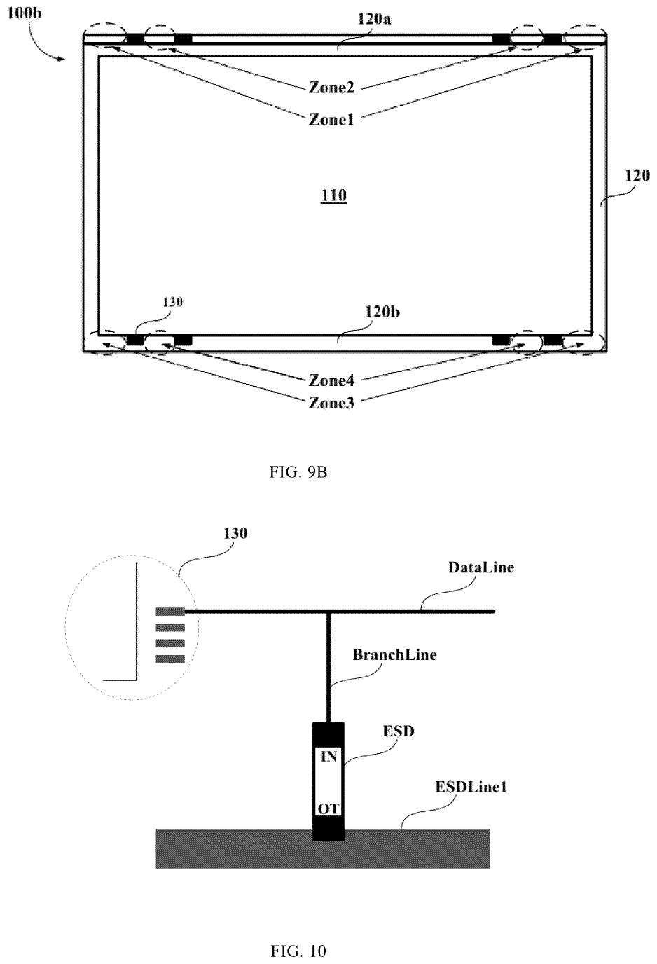

Referring to FIGS. 9a and 9b, a situation that an electrostatic discharge arrangement according to exemplary embodiments of the present disclosure is applied to a touch control display panel is schematically illustrated.

The touch control display panel shown in FIG. 9a is the same as the touch control display panel 100a shown in FIG. 1a, wherein the chips 130 are arranged in the DP side area 120a. It is shown that four chips 130 are arranged in the DP side area 120a, but this is merely exemplary and not limiting. Any suitable number of chips may be provided in the DP side area 120a according to actual needs. In some exemplary embodiments, the electrostatic discharge units may be arranged in the DP side area 120a. Specifically, the electrostatic discharge units may be applied to the areas Zone1 in the touch control display panel 100a according to the electrostatic discharge arrangements shown in FIG. 2, FIG. 4 and FIG. 5, the areas Zone1 are located at both end portions of the DP side area 120a of the touch control display panel 100a. The electrostatic discharge units may also be applied to the areas Zone2 in the touch control display panel 100a according to the electrostatic discharge arrangement shown in FIG. 6, each area Zone 2 is located between two adjacent chips 130 in the DP side area 120a of the touch control display panel 100a. The electrostatic discharge units may also be applied to the entire DP side area 120a of the touch control display panel 100a according to the electrostatic discharge arrangement shown in FIG. 7. In addition, the electrostatic discharge arrangement shown in FIG. 8 may be applied to the areas Zone2 of the touch control display panel 100a, each of which is located between two adjacent chips 130 in the DP side area 120a. Therefore, in the above situations, a plurality of data lines and a plurality of touch control lines extend from the operation area 110 of the touch control display panel 100a into the DP side area 120a to be electrically connected with the chips 130, and the plurality of data lines and the plurality of touch control lines are also respectively electrically connected with the corresponding electrostatic discharge units in the DP side area 120a.

In some exemplary embodiments, the electrostatic discharge units may be arranged in DPO side area 120b. Specifically, the electrostatic discharge units may be applied in the DPO side area 120b of the touch control display panel 100a according to the electrostatic discharge arrangements shown in FIG. 2, FIG. 4, FIG. 5 and FIG. 7. Accordingly, in this situation, the plurality of data lines and the plurality of touch control lines extend from the AA area 110 of the touch control display panel 100a into the DP side area 120a to be electrically connected with the chips 130, and the plurality of data lines and the plurality of touch control lines also extend from the AA area 110 into the DPO side area 120b to be electrically connected with the corresponding electrostatic discharge units, respectively.

In some exemplary embodiments, some electrostatic discharge units may be arranged in the DP side area 120a, and the other electrostatic discharge units may be arranged in the DPO side area 120b. Specifically, the electrostatic discharge units may be applied in the DP side area 120a and the DPO side area 120b of the touch control display panel 100a according to the electrostatic discharge arrangements shown in FIG. 2, FIG. 4, FIG. 5 and FIG. 7. Accordingly, in this situation, a plurality of data lines and a plurality of touch control lines extend from the AA area 110 into the DP side area 120a to be electrically connected with the chips 130 and respectively to be electrically connected with the corresponding electrostatic discharge units, and the plurality of data lines and the plurality of touch control lines also extend from the AA area 110 into the DPO side area 120b to be electrically connected with the corresponding electrostatic discharge units respectively.

The touch control display panel shown in FIG. 9b is the same as the touch control display panel 100b shown in FIG. 1b, wherein the chips 130 are arranged in the DP side area 120a and the DPO side area 120b. It is shown that eight chips 130 are arranged in DP side area 120a and DPO area 120b, but this is merely exemplary and not limiting. Any suitable number of chips may be provided in the DP side area 120a and the DPO side area 120b, respectively, according to actual needs. In some exemplary embodiments, electrostatic discharge units may be arranged in the DP side area 120a and the DPO side area 120b. Specifically, the electrostatic discharge units may be arranged in the areas Zone1 located at both end portions of the DP side area 120a of the touch control display panel 100b and/or the areas Zone3 located at both end portions of the DPO side area 120b of the touch control display panel 100b according to the electrostatic discharge arrangements shown in FIG. 2, FIG. 4 and FIG. 5. The electrostatic discharge units may also be arranged in the areas Zone2 in the DP side area 120a of the touch control display panel 100b, each of which is located between two adjacent chips 130, and/or be arranged in the areas Zone4 in the DPO side area 120b of the touch control display panel 100b, each of which is located between two adjacent chips 130, according to the electrostatic discharge arrangements shown in FIG. 6. The electrostatic discharge units may also be arranged in the entire DP side area 120a and the entire DPO side area 120b of the touch control display panel 100b according to the electrostatic discharge arrangement shown in FIG. 7. Furthermore, the electrostatic discharge arrangement illustrated in FIG. 8 may be arranged in the areas Zone2 and/or the areas Zone4 of the touch control display panel 100b. Thus, in the above situations, a plurality of data lines and a plurality of touch control lines extend from the AA area 110 of the touch control display panel 100b into the DP side area 120a, are electrically connected with the chips 130 in the DPO side area 120a, and are electrically connected with the corresponding electrostatic discharge units in the DPO side area 120a, respectively; and the plurality of data lines and the plurality of touch control lines also extend from the AA area 110 into the DPO side area 120b, are electrically connected with the chips 130 in the DPO side area 120b, and are electrically connected with the corresponding electrostatic discharge units in the DPO side area 120b, respectively.

It should be understood that the exemplary electrostatic discharge arrangements shown in FIGS. 2 and 4-8 can be applied to a touch control display panel individually or in any suitable combination, as long as such application does not depart from the technical principles, and the present disclosure is not limited thereto.

Referring to FIG. 10, connections from the chip and the electrostatic discharge unit to the signal lines respectively when the chip and the electrostatic discharge unit are located in the same area of the touch control display panel are schematically illustrated. As shown in FIG. 10, the chip 130 and the electrostatic discharge unit ESD are located in the same area of the touch control display panel, for example, both located in the DP side area 120a or both located in the DPO side area 120b. The data line DataLine extends into the area to be electrically connected with a corresponding pin of the chip 130, and the data line DataLine has a branch line BranchLine. The branch line BranchLine is electrically connected to an input terminal IN of the electrostatic discharge unit ESD, an output terminal OT of the electrostatic discharge unit ESD is electrically connected to a data line electrostatic discharge conductor ESDLine1, whereby the data line DataLine is electrically connected with the chip 130 and the electrostatic discharge unit ESD, respectively. FIG. 10 exemplarily shows a situation where a data line is electrically connected to the chip and the electrostatic discharge unit, respectively, and it should be understood that a situation where a touch control line is electrically connected to the chip and the electrostatic discharge unit, respectively, is similar to the situation shown in FIG. 10.

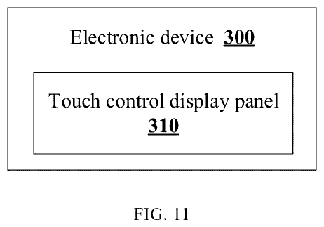

Referring to FIG. 11, a structure of an electronic device according to an exemplary embodiment of the present disclosure is schematically illustrated in the form of a block diagram. As shown in FIG. 11, the electronic device 300 includes a touch control display panel 310, wherein the touch control display panel 310 may be implemented as a touch control display panel to which the electrostatic discharge arrangements according to exemplary embodiments of the present disclosure are applied as shown in FIG. 9a or FIG. 9b. It should be understood that the electronic device 300 may be any suitable type of electronic device, such as, but not limited to, smartphones, mobile computers, notebook computers, tablet computers, and wearable devices such as smartwatches and bracelets, and the like. The present disclosure does not limit the specific type of electronic device as long as it includes a touch control display panel.

Terms used in the present disclosure are only used to describe embodiments in the present disclosure, and are not intended to limit the present disclosure. As used in the present disclosure, the singular forms “a,” “an” and “the” are intended to include the plural forms as well, unless the context clearly indicates otherwise. It should be further understood that the terms “comprise”, “include”, “comprising” and “including”, when used in the present disclosure, specify the presence of stated features, but do not preclude the presence or addition of one or more other features. As used in the present disclosure, the term “and/or” includes any and all combinations of one or more of the associated listed items. It should be understood that, although the terms “first”, “second” and “third”, etc. may be used in the present disclosure to describe various features, these features should not be limited by these terms. These terms are only used to distinguish one feature from another.

Unless otherwise defined, all terms (including technical terms and scientific terms) used in the present disclosure have the same meaning as commonly understood by one having ordinary skills in the art, to which the present disclosure belongs. It should be further understood that terms such as those defined in a common dictionary should be construed as having the same meaning as in the related art and/or in the context of the present specification, and will not be construed in an ideal or overly formal sense, unless defined explicitly as such in the present disclosure.

In the description of the Specification, expressions such as “one embodiment”, “some embodiments”, “an example”, “a specific example”, “some examples” or the like mean that a particular feature, structure, material or characteristic described in connection with the embodiment or example is included in at least an embodiment or example of the present disclosure. In this Specification, exemplary description of the above expressions is not necessarily directed to the same embodiment or example. Furthermore, the particular feature, structure, material, or characteristic as described may be combined in a suitable manner in any one or more embodiments or examples. Moreover, without contradicting each other and without violating the technical principles, different embodiments or examples and features of different embodiments or examples described in this Specification may be combined and assembled by a person skilled in the art, or some technical features may be omitted from different embodiments or examples described in this Specification, and embodiments or examples derived based on such combination, assembly or omission are still regarded as falling within the scope of the present disclosure.

Although the present disclosure has been described in detail in connection with some exemplary embodiments, it is not to be limited to the specific forms described in this disclosure. Rather, the scope of the present disclosure is defined only by the appended claims.

1. A touch control display panel comprising:
an operation area configured to perform display and sense a touch control operation from a user;
a peripheral area surrounding the operation area;
a plurality of data lines and a plurality of touch control lines extending from the operation area into the peripheral area, and in the peripheral area, each data line being electrically connected with an input terminal of a data line electrostatic discharge unit, an output terminal of the data line electrostatic discharge unit being electrically connected with a data line electrostatic discharge conductor, each touch control line being electrically connected with an input terminal of a touch control line electrostatic discharge unit, an output terminal of the touch control line electrostatic discharge unit being electrically connected with a touch control line electrostatic discharge conductor;
wherein the data line electrostatic discharge unit is configured to: bring the input terminal and the output terminal of the data line electrostatic discharge unit into conduction in response to a voltage applied at the input terminal of the data line electrostatic discharge unit being greater than or equal to a discharge voltage threshold, and break the conduction between the input terminal and the output terminal of the data line electrostatic discharge unit in response to a voltage applied at the input terminal of the data line electrostatic discharge unit being less than the discharge voltage threshold;
wherein the touch control line electrostatic discharge unit is configured to: bring the input terminal and the output terminal of the touch control line electrostatic discharge unit into conduction in response to a voltage applied at the input terminal of the touch control line electrostatic discharge unit being greater than or equal to the discharge voltage threshold, and break the conduction between the input terminal and the output terminal of the touch control line electrostatic discharge unit in response to a voltage at the input terminal of the touch control line electrostatic discharge unit being less than the discharge voltage threshold.

2. The touch control display panel according to claim 1, wherein:
the data line electrostatic discharge conductor is electrically connected with an input terminal of a redundancy data line electrostatic discharge unit, and an output terminal of the redundancy data line electrostatic discharge unit is electrically connected with a common voltage wiring in the peripheral area;
the touch control line electrostatic discharge conductor is electrically connected with an input terminal of a redundant touch control line electrostatic discharge unit, and an output terminal of the redundant touch control line electrostatic discharge unit is also electrically connected with the common voltage wiring.

3. The touch control display panel according to claim 2, wherein a plurality of data line electrostatic discharge units are arranged in a first row, a plurality of touch control line electrostatic discharge units are arranged in a second row, the first row and the second row are arranged in parallel.

4. The touch control display panel according to claim 1, wherein the touch control display panel further comprises a plurality of chips arranged in the peripheral area and a common voltage wiring arranged at a middle position of two adjacent chips, and for the common voltage wiring:
data line electrostatic discharge conductors comprise a first side data line electrostatic discharge conductor at a first side of the common voltage wiring and a second side data line electrostatic discharge conductor at a second side of the common voltage wiring, the second side is opposite to the first side, the first side data line electrostatic discharge conductor and the second side data line electrostatic discharge conductor are electrically connected through vias and a jumper line;
touch control line electrostatic discharge conductors comprise a first side touch control line electrostatic discharge conductor at the first side of the common voltage wiring and a second side touch control line electrostatic discharge conductor at the second side of the common voltage wiring, the second side is opposite to the first side, the first side touch control line electrostatic discharge conductor and the second side touch control line electrostatic discharge conductor are electrically connected through vias and a jumper line.

5. The touch control display panel according to claim 4, wherein for the common voltage wiring:
the first side data line electrostatic discharge conductor is electrically connected with an input terminal of a first side redundancy data line electrostatic discharge unit, and an output terminal of the first side redundancy data line electrostatic discharge unit is electrically connected with the common voltage wiring;
the second side data line electrostatic discharge conductor is electrically connected with an input terminal of a second side redundancy data line electrostatic discharge unit, and an output terminal of the second side redundancy data line electrostatic discharge unit is electrically connected with the common voltage wiring;
the first side touch control line electrostatic discharge conductor is electrically connected with an input terminal of a first side redundant touch control line electrostatic discharge unit, and an output terminal of the first side redundant touch control line electrostatic discharge unit is electrically connected with the common voltage wiring;
the second side touch control line electrostatic discharge conductor is electrically connected with an input terminal of a second side redundant touch control line electrostatic discharge unit, and an output terminal of the second side redundant touch control line electrostatic discharge unit is electrically connected with the common voltage wiring.

6. The touch control display panel according to claim 5, wherein for the common voltage wiring:
at the first side of the common voltage wiring, a plurality of data line electrostatic discharge units are arranged in a first row, a plurality of touch control line electrostatic discharge units are arranged in a second row, and the first row and the second row are arranged in parallel;
at the second side of the common voltage wiring, a plurality of data line electrostatic discharge units are arranged in a first row, a plurality of touch control line electrostatic discharge units are arranged in a second row, and the first row and the second row are arranged in parallel.

7. The touch control display panel according to claim 1, wherein the touch control line electrostatic discharge conductor is electrically connected with a ground line.

8. The touch control display panel according to claim 7, wherein a plurality of data line electrostatic discharge units are arranged in a first row, a plurality of touch control line electrostatic discharge units are arranged in a second row, and the first row and the second row are arranged in parallel.

9. The touch control display panel according to claim 7, wherein a plurality of data line electrostatic discharge units and a plurality of touch control line electrostatic discharge units are arranged in a row.

10. The touch control display panel according to claim 9, wherein:
the data line electrostatic discharge conductor is electrically connected with an input terminal of an additional data line electrostatic discharge unit, and an output terminal of the additional data line electrostatic discharge unit is electrically connected with a common voltage wiring in the peripheral area;
the touch control line electrostatic discharge conductor is electrically connected with an input terminal of an additional touch control line electrostatic discharge unit, and an output terminal of the additional touch control line electrostatic discharge unit is electrically connected with the common voltage wiring in the peripheral area.

11. The touch control display panel according to claim 1, wherein the data line electrostatic discharge conductor is electrically connected with a line for testing data line.

12. The touch control display panel according to claim 1, wherein the touch control display panel further comprises a plurality of chips arranged in the peripheral area, ground pins of adjacent two chips are electrically connected through a ground line between them, the ground line is at a side of the chip close to the operation area, and an orthographic projection of the ground line onto the touch control display panel is at least partially overlapped with an orthographic projection of a black matrix of the touch control display panel onto the touch control display panel.

13. The touch control display panel according to claim 12, wherein an orthographic projection of the common voltage wiring in the peripheral area onto the touch control display panel is at least partially overlapped with the orthographic projection of the black matrix on the touch control display panel.

14. The touch control display panel according to claim 1, wherein the peripheral area comprises a terminal interface side area and a terminal interface opposite side area that is opposite to the terminal interface side area, the terminal interface side area is provided with at least one chip, and the terminal interface opposite side area is provided with the data line electrostatic discharge unit and the touch control line electrostatic discharge unit;
wherein the plurality of data lines and the plurality of touch control lines extend from the operation area into the terminal interface side area to be electrically connected with the at least one chip, and the plurality of data lines and the plurality of touch control lines also extend from the operation area into the terminal interface opposite side area to be electrically connected with corresponding data line electrostatic discharge units and corresponding touch control line electrostatic discharge units, respectively.

15. The touch control display panel according to claim 1, wherein the peripheral area comprises a terminal interface side area and a terminal interface opposite side area that is opposite to the terminal interface side area, the terminal interface side area is provided with at least one chip, the data line electrostatic discharge unit and the touch control line electrostatic discharge unit;
wherein the plurality of data lines and the plurality of touch control lines extend from the operation area into the terminal interface side area to be electrically connected with the at least one chip, and are electrically connected with corresponding data line electrostatic discharge units and corresponding touch control line electrostatic discharge units, respectively.

16. The touch control display panel according to claim 1, wherein the peripheral area comprises a terminal interface side area and a terminal interface opposite side area that is opposite to the terminal interface side area, the terminal interface side area is provided with at least one chip, and the terminal interface side area and the terminal interface opposite side area are both provided with the data line electrostatic discharge unit and the touch control line electrostatic discharge unit;
wherein the plurality of data lines and the plurality of touch control lines extend from the operation area into the terminal interface side area to be electrically connected with the at least one chip, and be electrically connected with corresponding data line electrostatic discharge units and corresponding touch control line electrostatic discharge units, respectively;
wherein the plurality of data lines and the plurality of touch control lines also extend from the operation area into the terminal interface opposite side area to be electrically connected with corresponding data line electrostatic discharge units and corresponding touch control line electrostatic discharge units, respectively.

17. The touch control display panel according to claim 1, wherein the peripheral area comprises a terminal interface side area and a terminal interface opposite side area that is opposite to the terminal interface side area, the terminal interface side area is provided with at least one chip, the terminal interface opposite side area is also provided with at least one chip, the terminal interface side area and the terminal interface opposite side area are both provided with the data line electrostatic discharge unit and the touch control line electrostatic discharge unit;
wherein the plurality of data lines and the plurality of touch control lines extend from the operation area into the terminal interface side area to be electrically connected with at least one chip in the terminal interface side area, and be electrically connected with corresponding data line electrostatic discharge units and corresponding touch control line electrostatic discharge units in the terminal interface side area, respectively;
wherein the plurality of data lines and the plurality of touch control lines also extend from the operation area into the terminal interface contralateral area to be electrically connected with at least one chip in the terminal interface opposite side area, and be electrically connected with corresponding data line electrostatic discharge units and corresponding touch control line electrostatic discharge units in the terminal interface opposite side area, respectively.

18. The touch control display panel according to claim 1, wherein a circuit structure of the data line electrostatic discharge unit and the touch control line electrostatic discharge unit comprises:
a first transistor, a control electrode and a first electrode of which are both electrically connected with the input terminal;
a second transistor, a first electrode of which is electrically connected with the control electrode of the first transistor, and a control electrode and a second electrode of which are electrically connected with a second electrode of the first transistor;
a third transistor, a first electrode and a control electrode of which are both electrically connected with the second electrode of the second transistor; and
a fourth transistor, a first electrode of which is electrically connected with the control electrode of the third transistor, a control electrode and a second electrode of which are electrically connected with a second electrode of the third transistor and also electrically connected with the output terminal;
wherein the first transistor, the second transistor, the third transistor and the fourth transistor are N-type transistors.

19. The touch control display panel according to claim 18, wherein the first transistor, the second transistor, the third transistor and the fourth transistor are thin film transistors.

20. An electronic device comprising the touch control display panel according to claim 1.
